(19) United States
(12) Patent Application Publication
(10) Pub. No.: US 2010/0193288 A1
(43) Pub. Date: Aug. 5, 2010

(54) COMPACT BAILOUT POUCH WITH ROPE COILING APPARATUS

(76) Inventor: Juancarlos Colorado, Petaluma, CA (US)

Correspondence Address: STAINBROOK & STAINBROOK, LLP, 412 AVIATION BOULEVARD, SUITE H, SANTA ROSA, CA, 95403, US

(21) Appl. No.: 12/680,172

(22) PCT Filed: Sep. 18, 2008
(86) PCT No.: PCT/US08/76904

§ 371 Date: Mar. 25, 2010

Related U.S. Application Data
(60) Provisional application No. 60/975,343, filed on Sep. 26, 2007.

(51) Int. Cl. A62B 1/18

(52) U.S. Cl. 182/3; 414/800

(57) ABSTRACT

A rapid egress apparatus that includes a bailout pouch formed by a plurality of fabric panels that open to accommodate a coiled rope and close to stow a coiled rope, wherein the pouch includes an opening through which a rapid egress rope may be pulled from said bailout pouch, a rope, and a rope coiling apparatus for rapidly forming the rope into a coil comprising a plurality of stacked figure eight portions.

### BACKGROUND OF THE INVENTION

1. Technical Field

The present invention relates generally to safety equipment, and more particularly to firefighter safety equipment, and still more particularly to a compact bailout pouch and rope coiling system for attachment to and use in connection with a firefighter's trucker belt and/or extrication harness.

2. Background Art

Firefighters routinely confront the danger of entrapment in burning buildings, some of which are multistory buildings. When rapid egress or escape is necessary, it is common for firefighters to use a rope in connection with an emergency climbing harness to rappel to a safe level or to the ground. The equipment currently needed for this feat is heavy, bulky, and potentially dangerous to haul about during firefighting maneuvers. Accordingly, firefighters are reluctant to carry it into a burning structure. Furthermore, the process of putting on the equipment and then deploying it for use can be time consuming and complicated in an urgent situation, particularly when a broiling sea of smoke churns the air and blinds and chokes the firefighter. Still further, it is a time consuming matter to a rapid egress pouch with a rapid egress rope, as the packing must be done in such a manner as to ensure smooth and easy pay out without any risk of catching or entanglement. Thus, it is uncommon for firefighters and rescue personnel to allow others to pack their rapid egress bags.

There exists a need, therefore, to provide a rapid egress bailout pouch having a rope coiling system especially adapted for packing the pouch with safety rope for use in emergencies.

### DISCLOSURE OF THE INVENTION

The present invention is compact bailout pouch a rope coiling system for a rapid egress system used by firefighters and rescue personnel. The system includes as its principal elements a pouch for containing a coil of rope, a safety rope employed in descending from a height should the need for rapid egress arise, and a rope coiling apparatus for rapidly coiling the rope in a stacked plurality of figures eights that pack tightly in the rope bag yet ensure that the rope will pay out of the pouch without catching or tangling.

It is a fundamental object of the present invention to provide a new and improved bailout pouch and rope coiling system that ensures tangle free pay out of a rope from the bailout pouch when used for a rapid egress operation.

It is another object of the present invention to provide a new and improved rope coiling system that ensures that no error in coiling is made before the rope is packed in the bailout pouch.

A further object or feature of the present invention is to provide a new and improved rope coiling system that facilitates rapid and essentially error free figure eight rope coiling configurations.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

Accordingly, before explaining the preferred embodiment of the disclosure in detail, it is to be understood that the disclosure is not limited in its application to the details of the construction and the arrangements set forth in the following description or illustrated in the drawings. The inventive apparatus described herein is capable of other embodiments and of being practiced and carried out in various ways.

As such, those skilled in the art will appreciate that the conception, upon which this disclosure is based may readily be used as a basis for designing other structures, methods, and systems for carrying out the several purposes of the present invention. It is important, therefore, that the claims are regarded as including such equivalent constructions as far as they do not depart from the spirit and scope of the present invention. Rather, the fundamental aspects of the invention, along with the various features and structures that characterize the invention, are pointed out with particularity in the claims annexed to and forming a part of this disclosure. For a better understanding of the present invention, its advantages and the specific objects attained by its uses, reference should be made to the accompanying drawings and descriptive matter in which there is illustrated the preferred embodiment and best mode of practicing the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front right perspective view of the functional and structural elements comprising the compact bailout pouch and rope coiling system of the present invention;

FIG. 1A is a front perspective view showing the bailout pouch with its flaps in an open configuration;

FIG. 1B is a rear perspective view thereof;

FIG. 2A is an upper front perspective view of the rope coiling apparatus used with the compact bailout pouch of the present invention, showing a rope first placed to commence a coiling procedure;

FIG. 2B is an upper front perspective view of the rope and rope coiling apparatus of FIG. 2A showing the rope partially coiled on the rope coiling apparatus;

FIG. 2C is the same perspective showing the rope fully coiled on the rope coiling apparatus;

FIG. 2D is the same perspective showing the rollers of the rope coiling apparatus removed and the rope coil partly collapsed in preparation for removal from the rope coiling apparatus for placement in the compact bailout pouch;

FIG. 3A is a front perspective view showing use of the rope coiling apparatus to insert the coiled rope in the compact bailout pouch;

FIG. 3B is a front perspective view showing the compact bailout pouch in a closed configuration with the coiled rope enclosed inside;

FIG. 4A is a front perspective view showing the compact bailout pouch and the pay out end of the bailout rope prepared for connection to a trucker's waist belt;

FIG. 4B is a front perspective view showing the bailout pouch and rope operatively connected to a waist belt and ready for use; and

FIG. 5 is a perspective view showing the belt as worn by a user with the hook end of the bailout rope poised for connection to a secure structure.

### BEST MODE OF PRACTICING THE INVENTION

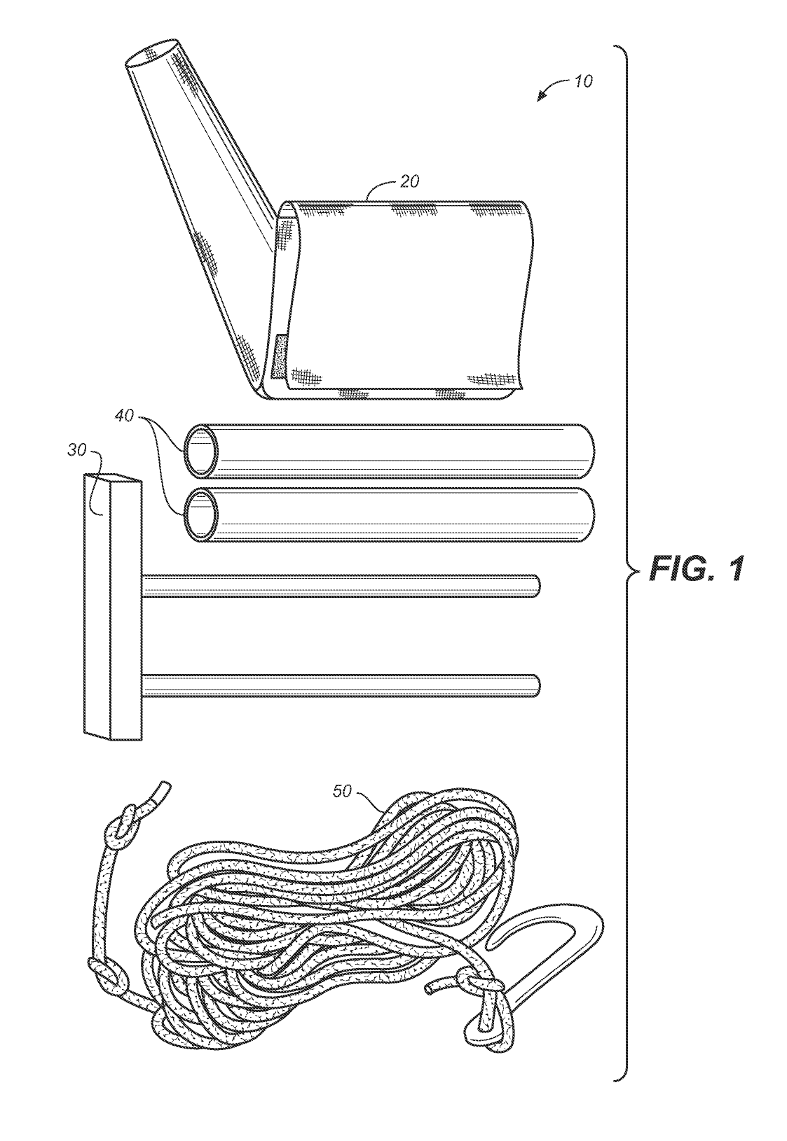

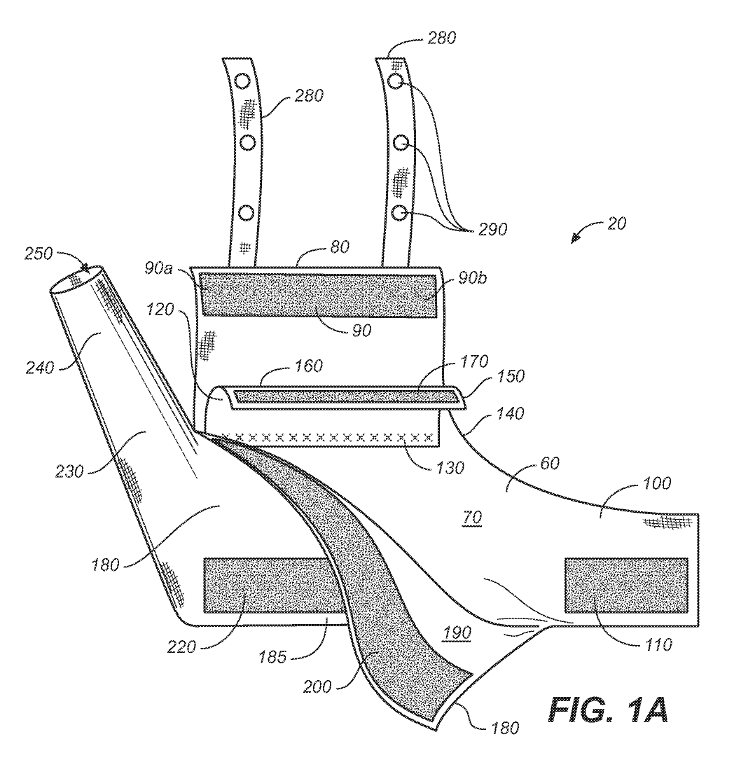

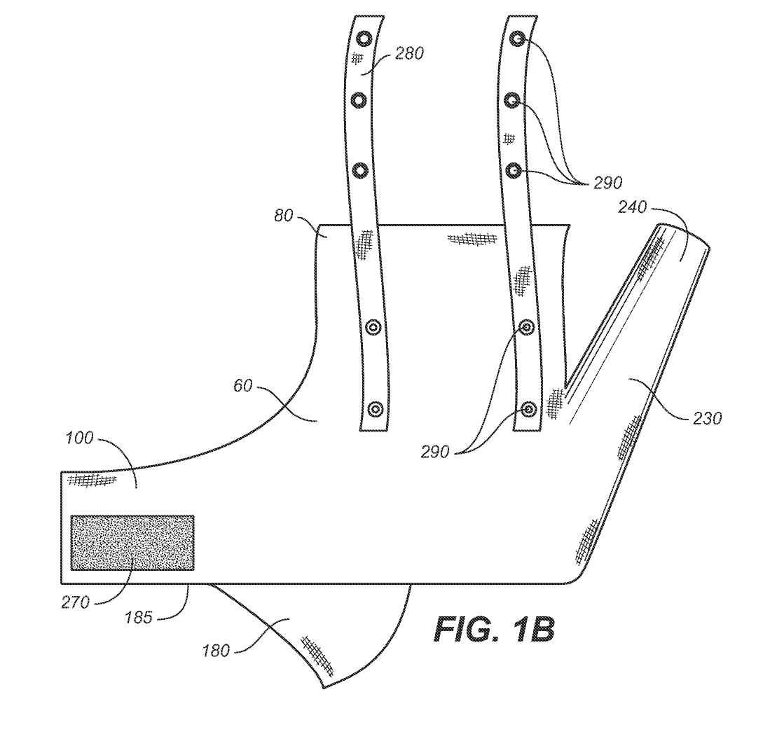

Referring to FIGS. 1 through 5, wherein like reference numerals refer to like components in the various views, there is illustrated therein a new and improved firefighter's compact bailout pouch and rope coiling apparatus, generally denominated 10 herein.

Referring first to FIG. 1, it will be seen that in the most general terms, the inventive method and apparatus includes a compact bailout pouch 20, a bailout rope rapid coiling apparatus 30 with removable coiling tubes 40, and a bailout rope 50.

FIGS. 1A and 1B show that the compact bailout pouch 20 is formed by a plurality of fabric panels or flaps that are configured to allow selective opening and closure. When opened, the pouch will accommodate the placement of a large coil of rope, and when closed, the coil of rope will be contained therein, to be fed out or paid out only in an emergency when an end of the rope is pulled outwardly from the pouch. As is seen in the drawings, the pouch includes a back panel 60 with an interior side 70, an upper flap 80 with fastener apparatus (preferably hook and loop material) 90 on its interior side, including an anterior portion 90a and a dorsal portion 90b, and a dorsal flap 100 having fastener apparatus (again, preferably hook and loop material) 110 on its interior side. A rope-engaging fabric flap 120 includes a lower portion 130 sewn onto the interior side of the back panel proximate the base portion 140 of the upper flap 80. The upper portion 150 of the rope-engaging flap may be rolled forward to expose a back side 160 having hook and loop material 170.

Next, the compact bailout pouch includes a front flap 180 having an interior side 190 with hook and loop material 200 adapted for matable connection with the complementary hook and loop material 170 of the rope-engaging flap 120. The front flap further includes an exterior side 210 with a hook and loop strip 220 adapted for matable connection to the anterior portion 90a of the complementary hook and loop material 90 of upper flap 80. The front flap 180 and back panel join in a fold 185. It will be appreciated that flap 80 may be sized to wrap entirely around and under front flap 180, and back panel 60 may be provided with a length of fastener material, such that flap 80 attaches to back panel 60. This is especially important when the bailout pouch is used in firefighting, as the wrap prevents inadvertent opening of the pouch caused by violent updrafts of hot air and fire.

Next, and still referring to FIGS. 1A and 1B, the compact bailout pouch includes an anterior sleeve 230 through which rope passes during an egress operation. The anterior sleeve extends integrally in a funicular or cylindrical configuration from the back panel and front flap. The outer end 240 of the anterior sleeve 230 includes an opening 250 through which a bailout rope and select attached rigging are paid out during an egress operation. As will be appreciated, the sleeve may be any of a number of suitable lengths, and the opening in the sleeve may be large or small according to the size of the rope and the hardware employed.

Referring to FIG. 1B, the dorsal flap 100 includes a back side 260 having hook and loop material 270 adapted for matable connection with the dorsal portion 90b of the complementary hook and loop material 90 of the upper flap 80.

Finally, the compact bailout pouch includes belt connection means, preferably one or more straps 280, sewn or otherwise connection to the pouch, and having fastening means for forming a closed and coupled loop after placement around a waist belt or other extrication harness strap. Such fastening means may comprise a plurality of snaps 290, or hook and loop material, or other commonly used fastening means.

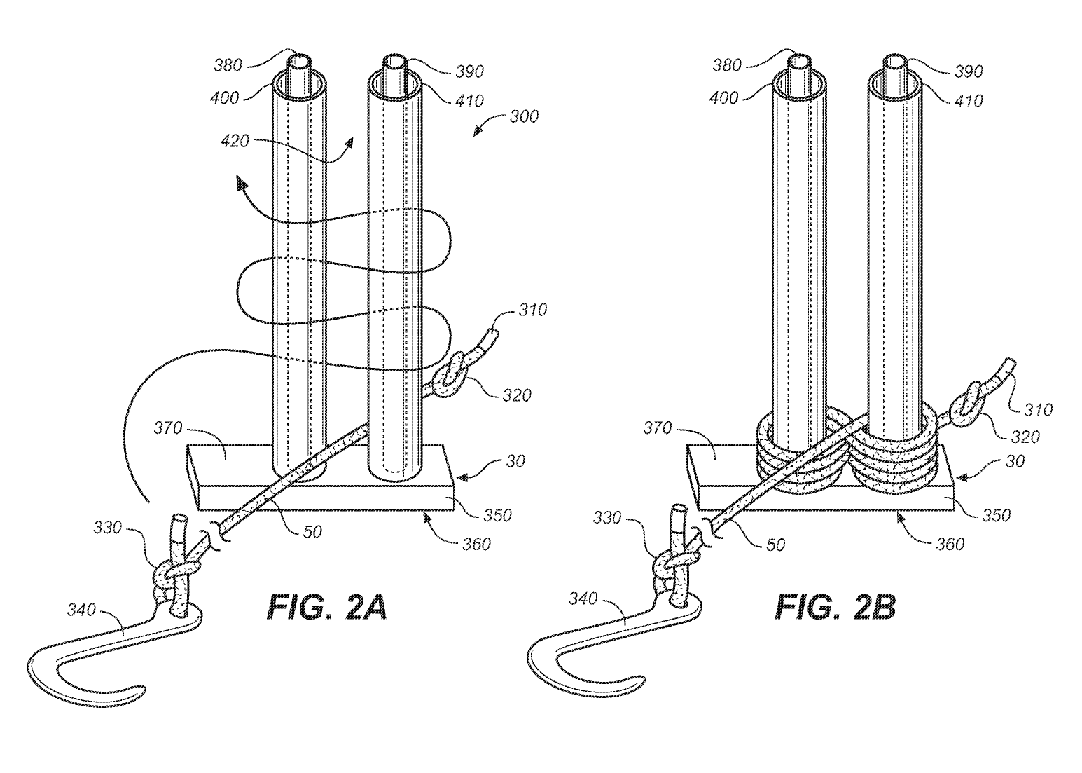

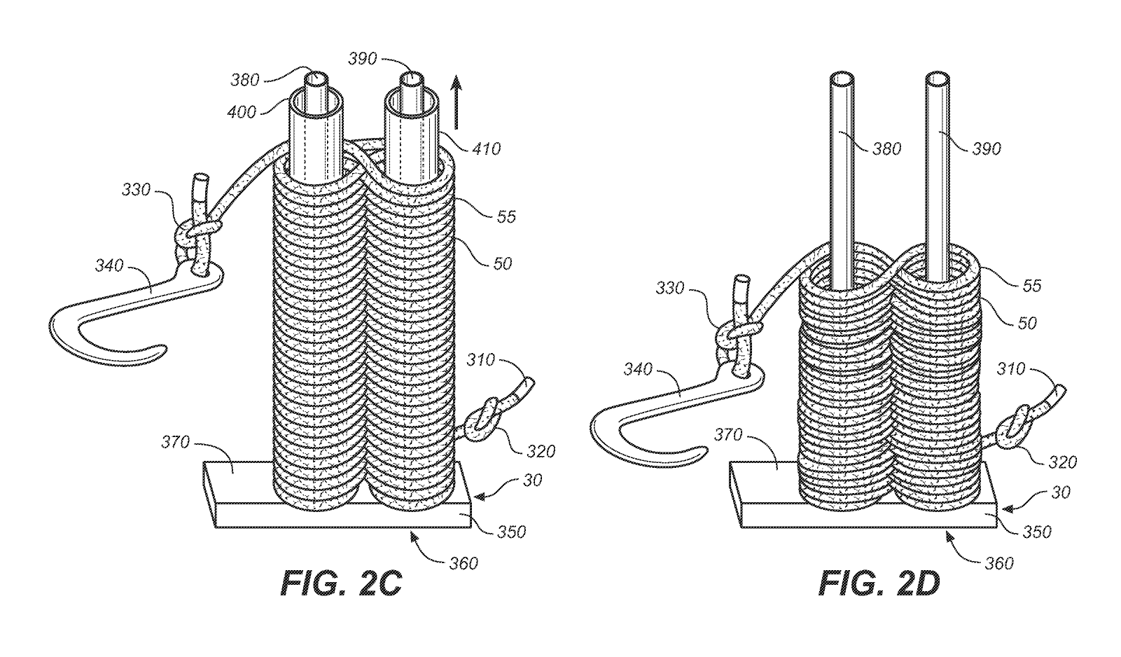

Referring next to FIGS. 2A through 2d, there is shown a bailout rope rapid coiling apparatus 300 and the method steps for using the same. The bailout rope 50 includes a proximal end 310 having at least one knot 320, and preferably two or three, and a distal end 330, which is typically tied to a hook 340 or other device for connecting to a fixed object in a building or other structure.

The rapid coiling apparatus 30 includes a base portion 350 having a substantially planar bottom 360 which facilitates stable placement on a flat surface. The base further includes and upper side 370 on which first and second coiling rods 380, 390, are disposed. When the base is placed on a flat surface, the first and second coiling rods are substantially vertical and substantially parallel. To commence a figure eight coiling procedure, the base is placed on generally flat surface, such as a table or the floor; first and second coiling tubes 400, 410, one each, are then placed over one of the coiling rods. The rope 50 is placed between the coiling tubes with the proximal end near the second coiling tube. Proceeding sequentially and alternately, the rope is partially wrapped in a clockwise direction around the first coiling tube until it is threaded through the space 420 between the tubes, at which time it is then wrapped partially in a counterclockwise direction around the second coiling tube until the rope is again inserted in the space between the tubes, at which point the process is repeated until the rope is entirely coiled into a plurality of stacked figure eights 55 around the two coiling tubes (see FIG. 2C). When the coiling is completed, the coiling is checked for errors, which are conspicuous departures from the illustrated stacking pattern, and any found errors are corrected by uncoiling the rope above the error and recoiling from that point. When the coiling is clearly error free, the coiling tubes are removed (see FIGS. 2C and 2D), and the coiled figure eights 55 are allowed to compress slightly (see FIG. 2D). This can be encouraged somewhat simply by pressing the coil down with the hands.

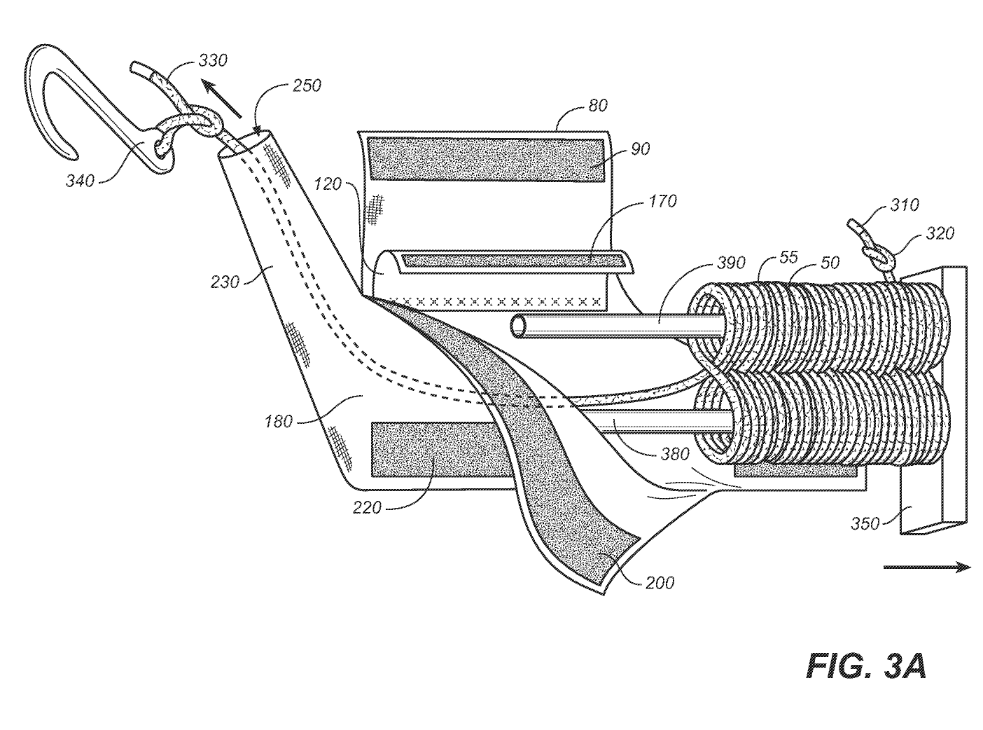

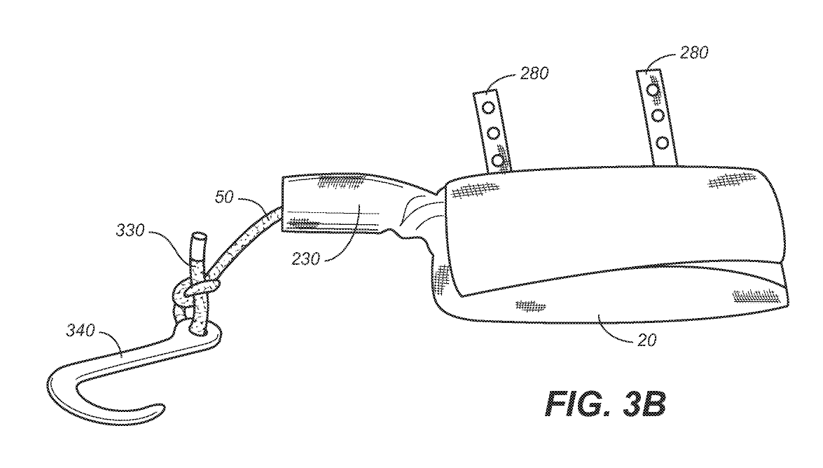

FIG. 3A shows how the coiled rope is retained on the rapid coiling apparatus for loading in the compact bailout pouch. Notably, the outer ends of the coiling rods 380, 390 are inserted into the dorsal portion of the pouch between the bottom crease or fold 185 where the back panel 60 and front flap 180 join and the interior flap 120, which may be partly rolled over the upper portion of the FIG. 8 rope coil. The hook or connector device 340 is pulled through the opening 250 in the anterior sleeve 230. The coil is then thoroughly pushed deeper into the pouch until it is captured between the front flap and back panel, at which point the front flap is closed over the interior flap, the dorsal flap is closed over the front flap, and the upper flap is closed over the dorsal and front flaps. The pouch in the closed configuration is shown in FIG. 3B.

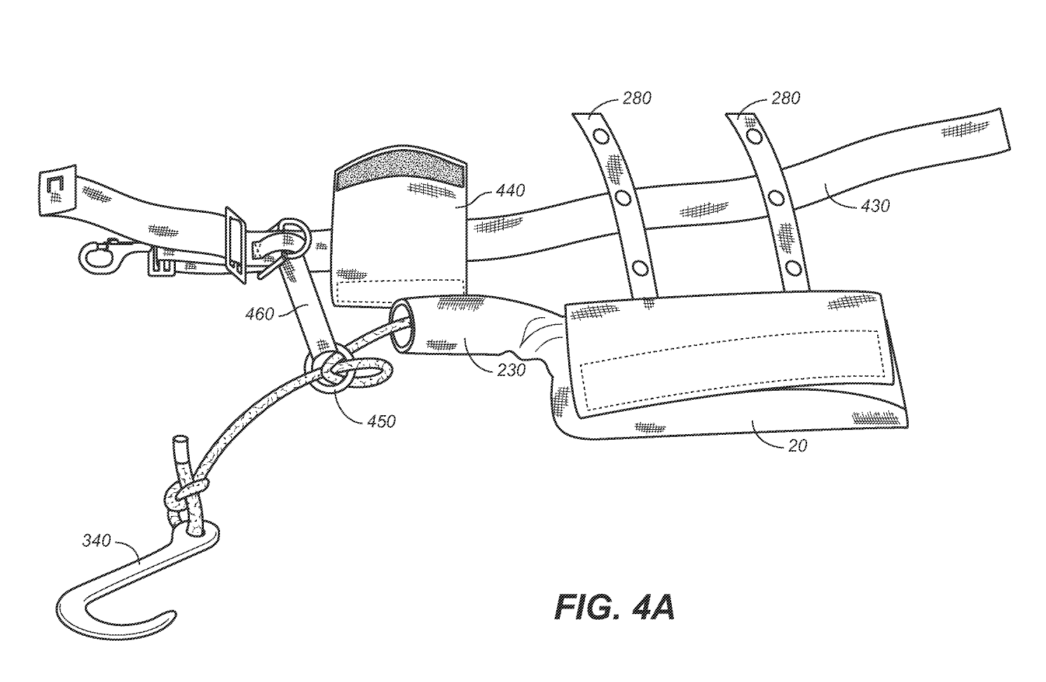

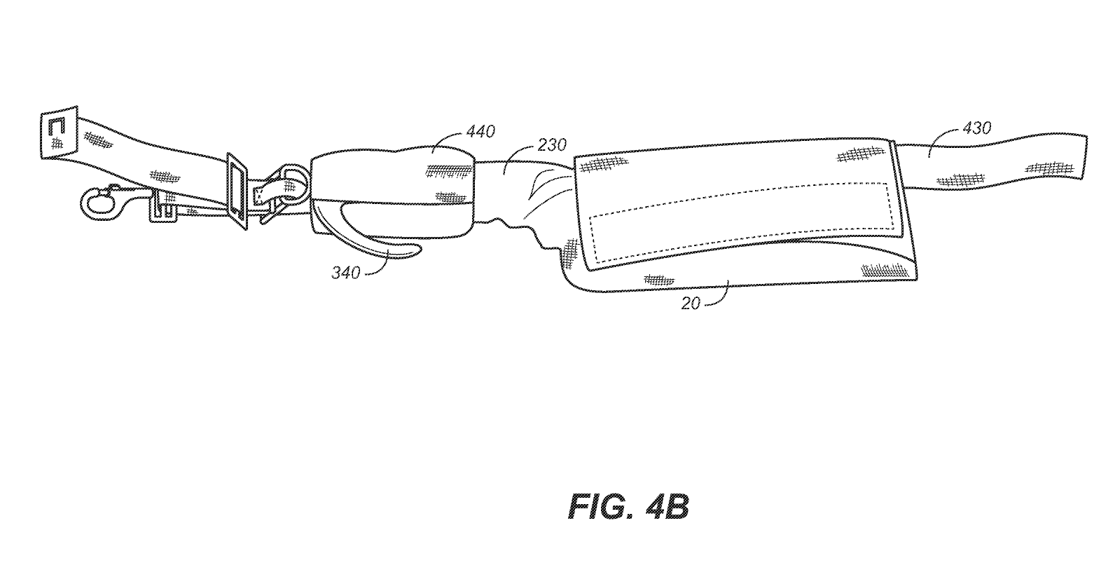

FIGS. 4A and 4B show how the completed closed pouch and coiled rope is installed on the waist belt 430 of a trucker's belt and/or extrication harness. Preferably the waist belt includes a flap affixed to the belt and positioned for capturing the anterior sleeve and connector hook 340 until the user is ready to deploy the rope. The rope is further threaded through a munter plate, O-ring, D-ring, or any of a number of common and suitable descender devices 450, which may, in turn, be connected to the waist belt with a carabineer, ring, clip, or (as shown) a sewn strap 460.

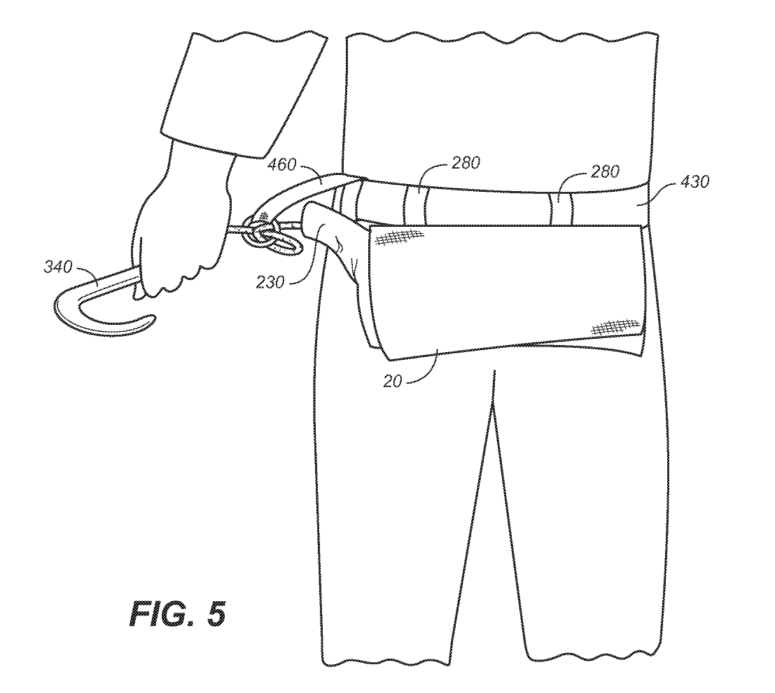

FIG. 5 shows the inventive compact bailout pouch attached to a waist belt with the free end of the bailout rope prepared for deployment and pay out through the opening in the anterior sleeve. If the user descends over a sufficient length of rope, the descent will ultimately be stopped when the knots in the rope reach the descender device, through which they will not pass.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

For instance, the fabric flaps are described herein has having fastener apparatus in the form of complementary hook and loop fabric material. Those with skill in the art will immediately appreciate that alternative fastening means are suited for use in approximating and connecting the flaps comprising the above-described bailout pouch. Such means could include, by way of example, snaps, buttons and holes, toggles and holes, zippers, and so forth.

Therefore, the above description and illustrations should not be construed as limiting the scope of the invention, which is defined by the appended claims.

What is claimed as invention is:

1. A rapid egress apparatus, comprising:
a bailout pouch 20 formed by a plurality of fabric panels that open to accommodate a coiled rope 50 and close to stow a coiled rope, such that when closed, said pouch includes an opening through which a distal end 330 of said coiled rope may be pulled from said bailout pouch;
a rope 50 and;
a rope coiling apparatus 30 for rapidly forming said rope into a coil consisting of a plurality of stacked figure eight portions 55.

2. The apparatus of claim 1, wherein said rope coiling apparatus 30 includes at least two substantially parallel coiling rods.

3. The apparatus of claim 2, wherein said coiling rods are disposed on a base portion 350 having a substantially planar bottom 360 for placement on a flat surface.

4. The apparatus of claim 3, further including coiling tubes 400, 410, one each placed over one of said coiling rods, said coiling rods spaced apart from one another and said coiling tubes sized such that there is a space 420 between said coiling tubes sufficient to pass said rope.

5. The apparatus of claim 1, wherein said coiling rods are disposed on a base portion 350 having a substantially planar bottom 360 for placement on a flat surface.

6. The apparatus of claim 5, further including coiling tubes 400, 410, one each placed over one of said coiling rods, said coiling rods spaced apart from one another and said coiling tubes sized such that there is a space 420 between said coiling tubes sufficient to pass said rope.

7. The apparatus of claim 1, wherein said plurality of fabric panels includes:
a back panel 60 having an interior side 70, an upper flap 80 having a base portion 140, and having fastener apparatus 90 on said interior side, including an anterior portion 90a and a dorsal portion 90b, and a dorsal flap 100 integral with said base portion of said upper flap 80 and having fastener apparatus 110 on its interior side, wherein said dorsal flap 100 includes a back side 260 having fastener apparatus 270 adapted for matable connection with said dorsal portion 90b of said fastener apparatus 90 of said upper flap 80;
a rope-engaging fabric flap 120 having a lower portion 130 sewn onto said interior side 70 of said back panel 60 proximate said base portion 140, and an upper portion 150 that may be rolled forward to expose a back side 160 having fastener apparatus 170;
a front flap 180 having an interior side 190 with fastener apparatus 200 adapted for matable connection with said fastener apparatus 170 of said rope-engaging flap 120, and an exterior side 210, wherein said front flap 180 and said back panel join in a fold 185; and
an anterior sleeve 230 extending integrally from said back panel and said front flap, and having an outer end 240 that includes an opening 250 through which a bailout rope and select attached rigging may be passed.

8. The apparatus of claim 7, wherein said exterior side 210 of said front flap 180 further fastener apparatus 220 adapted for matable connection to said anterior portion 90a of said fastener apparatus 90 of said upper flap 80.

9. The apparatus of claim 7, wherein said back side 260 of said back panel 60 includes fastener material for matable connection to said anterior portion 90a of said fastener apparatus 90 of said upper flap 80.

10. The apparatus of claim 7, further including a belt connection apparatus.

11. The apparatus of claim 10, wherein said belt connection apparatus comprises at least one strap 280 connected said pouch and each of said at least one strap includes a fastener for forming a closed and coupled loop after placement around a waist belt or other extrication harness strap.

12. A method of packing a rapid egress pouch, comprising the steps of:
(a) providing a pouch for containing a coil of rope, the pouch including a coil-containing portion and an opening through which to feed a rope from the pouch;
(b) providing a rope coiling apparatus having at least two substantially parallel coiling rods, first and second coiling tubes, one each disposed over one of the coiling rods, and a space between the coiling tubes when so disposed such that the rope can be passed between the coiling tubes;
(c) providing a rope having a proximal end and a distal end;
(d) placing the proximal end of the rope between the coiling tubes with the proximal end near the second coiling tube;
(e) partially wrapping the rope in a first rotational direction around the first coiling tube until it is threaded through the space between the coiling tubes, then wrapping the rope partially in a second, opposite, direction around the second coiling tube, until the rope is again inserted in the space between the tubes;
(f) repeating step (e) alternately and sequentially until the rope is entirely coiled in a plurality of stacked figure eights around the two coiling tubes;
(g) checking the coiling for errors and correcting any found by uncoiling the rope above the error and recoiling from that point;
(h) removing the coiling tubes when the coiling is error free; and
(i) compressing or allowing the coiled figure eights to compress.
(j) placing the coiled figure eights in the bailout pouch;
(k) pulling a distal end of the coiled rope through the bailout pouch opening; and
(l) closing the pouch over the coiled rope.

13. The method of claim 10, further including the steps of:
(i-1) after step (i) and before step (j), retaining the rope on the rope coiling apparatus for loading in the bailout pouch; and
(i-2) inserting the outer ends of the coiling rods into the pouch.
